(19) United States
(12) Patent Application Publication
(10) Pub. No.: US 2006/0202471 A1
(43) Pub. Date: Sep. 14, 2006

(54) Electro-fusion joining system for thermoplastic piping systems

(76) Inventors: Bradley K. Weisbond, Overland Park, KS (US); Christopher G. Ziu, Lenexa, KS (US)

Correspondence Address: FISH & RICHARDSON PC, P.O. BOX 1022, MINNEAPOLIS, MN, 55440-1022, US

(21) Appl. No.: 11/073,436

(22) Filed: Mar. 7, 2005

(51) Int. Cl. F16L 47/02

(52) U.S. Cl. 285/21.1

(57) ABSTRACT

An electro-fusion drainage system coupling has a tubular body with outer and inner substantially parallel surfaces. The inner surface defines a passageway from end to end. A resistive heating element is disposed in the passageway. The predetermined distance represents a desired insertion distance of the pipe into the coupling body passageway. The electro-fusion coupling may further include a stop positioned in the passageway to contact the end of the thermoplastic pipe inserted into the passageway. Other implementations include an electro-fusion coupling with a fitting integrally formed on a second end and a thermoplastic piping system presented in a kit. Methods of the invention are also described.

### TECHNICAL FIELD

This invention relates to electro-fusion couplings and fittings for thermoplastic piping.

### BACKGROUND

Thermoplastic piping has been used to convey corrosive waste discharge from research laboratories since the late 1960s. Prior to that time, borosilicate glass piping was the standard material of choice for the aboveground portions of the piping systems located within buildings. For the underground portions of the systems, high-silicon alloy iron (Duriron) was the material of choice.

In the early 1960s, attempts were made to replace glass and Duriron with low temperature, inexpensive thermoplastics such as polyvinyl chloride (PVC) and acrylonitrile-butadiene-styrene copolymer (ABS), as well as polyethylene. However, PVC and ABS both proved to lack the necessary chemical resistance to common laboratory solvents and environmental stress crack resistance to common disinfectant ingredients such as non-ionic surfactants. Further, PVC, ABS and polyethylene alike all proved to lack the necessary stiffness at temperatures greater than 140° F. Since mixtures of laboratory wastes causing exothermic chemical reactions and building temperature changes during construction can both result in thermal expansion, piping materials which soften at 140° F. are more likely to sag and twist between supports, resulting in the development of sagging and back-pitch (back-pitch refers to a situation where the pipes that are supposed to be “pitched” at a constant slope downward, instead bow upwards in places thereby preventing gravity from causing the fluid to flow freely). In drainage systems, back-pitch is highly undesirable as this can result in improper drainage and the possibility of fluid back-up through the system.

Thus, it was determined early on that one material having an ideal mix of chemical resistance to a wide range of acids, bases and organic and inorganic solvents, and a higher glass transition temperature than PVC, ABS, and PE was polypropylene (PP). Upon its introduction in the late 1960s, polypropylene quickly grew to become the standard in the industry. One limitation of polypropylene however, is that due to its resistance to solvents, joining by solvent cementing is not a ready possibility. The material is instead joined either by some form of heat fusion, or by mechanical connection. Most forms of heat fusion that existed up to that point were limited to heat element socket fusion or heat element butt fusion, both of which have always been considered cumbersome, especially in fitting-intensive piping arrangements such as laboratory waste piping. To address this problem, and to facilitate easier installation of polypropylene into laboratory facilities, a new joining process referred to as “electro-fusion” was developed, e.g., as described in Blumencranz, U.S. Pat. Nos. 3,378,672; 3,465,126; and 3,506,519. This process, involving a wire coil imbedded within the plastic at joint locations, and through which electricity is later passed to create heat and fusion (with pressure applied via external clamping) was developed to make it easier to install polypropylene.

In addition to electro-fusion, once polypropylene corrosive waste systems proved to be a commercial success, mechanical methods of connection were also established as an alternative method to join pipes. Mechanical methods, which involved fittings and couplings of a completely different design from that of the electro-fusion variety, soon gained popularity in aboveground installations, particularly in the under-sink plumbing.

After the historic MGM Hotel fire in Las Vegas twenty-five years ago, new building standards were enacted to require that building materials for air handling areas and areas classified as return air plenums satisfy certain flame and smoke density requirements (namely flame spread value of less than 25 and smoke density rating of less than 50 according to ASTM E-84). Polypropylene, while being excellent chemically, unfortunately burns readily and produces relatively dense smoke, and as such is typically unable to meet these required values. Therefore, for a period of time, in those areas classified as fire rated, users were forced to transition to borosilicate glass or duriron through some means of mechanical connection. However, in the early 1990s, a special formulation of polyvinylidene fluoride (PVDF), a fluoropolymer thermoplastic material known for its fire resistance as well as its excellent chemical resistance, was able to pass the required flame spread and smoke density requirements (when tested to ASTM E-84) of most building codes. As a result, PVDF has since become the standard corrosive waste material of choice in those portions of buildings designated as fire rated areas.

PVDF, like polypropylene, is highly solvent resistant, and able to be joined by the same methods inherently used on PP (e.g. electro-fusion and other heat fusion methods, and mechanical joining methods).

While the electro-fusion method has appeal, it has not been without its problems as there are many subtleties that can result in problems in joining polypropylene and PVDF by electro-fusion. Additionally, subtleties in joint design, coupled with inadequate joining, can lead to failures occurring in service after a prolonged period of time. For this reason, many projects have suffered through severe installation difficulties, while others have seen after installation failures occur due to chemical attack mechanisms.

Generally, contractors tend to prefer the labor savings and ease of joining offered by mechanical joining methods, whereas engineers and code officials tend to prefer the use of fused joints in areas that are inaccessible, such as behind walls and in underground locations. Most engineers tend to view fused joints as having less likelihood of leaks over time. Conversely, most engineers and code officials tend to view mechanical methods as having a distinct possibility of loosening over time, whereby leaks could result. As a result, most mechanical joints are limited to installations where there is access to repair the joints, if needed.

In prior art electro-fusion methods developed for corrosive waste systems, the methods involve putting a minimum amount of heat into the joints, and using a coupling design with a small mass of material. In order to create pressure between the coupling or fitting coupling portion and the pipe to be fused, external clamps are required during the electro-fusion process. The clamping force required is difficult to quantify. If the contractor does not apply a sufficient clamping force, or too much clamping force is applied, a poor joint can result. Since there are many human elements involved in the joining processes, and a minimum amount of heat is introduced into the joints, the results are often less than satisfactory. In the best-case scenario, when all steps of the fusion process are performed properly, the joints are typically rated for drainage pressures only. However, if one or more of the steps involved are not followed properly, or tolerances are less than ideal, the result may be a high rate of leaks encountered during the joining process. In any event, the requirement for clamping adds a significant amount of additional labor on sizeable projects.

In prior art electro-fusion systems as shown in U.S. Pat. Nos. 6,450,544 and 6,250,686, a single coupling incorporates changeable sleeves to allow for joining by either electro-fusion or mechanical means using the same coupling. However, while providing some advantages in reducing the number of parts needed for manufacture and inventory, the prior art systems do not solve some of the fundamental problems described in the previous paragraphs. One of the problems with the prior art systems is the need to use manually-applied external clamping force during the electro-fusion cycle (accomplished by hand tightening of a nut). Additionally, in the prior art, when joining by either electro-fusion or mechanical method a short piece (“pup”) of pipe is required when making the fitting-to-fitting connections. Since the mechanical coupling utilizes an external threaded nut, this can loosen over time due to expansion and contraction, leading to a failure later in service. Further, with the electro-fusion coupling, the installer has no way to apply a clamping force, in the event a second or third fusion cycle is required if the first cycle did not create a pressure tight joint, because the threads may become fused tight. Since this type of joint uses a minimum amount of heat and depends on manual force for applying pressure during the joint, this problem occurs in many installations.

Another disadvantage in prior art electro-fusion systems used in corrosive waste systems, as well as in many prior art mechanical joint systems, is that a fitting-to-fitting joint requires that a short pipe nipple be cut and prepared, resulting in additional labor and two distinct joints.

Mechanical joints are satisfactory for installation in certain accessible areas, and electro-fusion is satisfactory underground and behind walls, but in applications involving both methods, the requirement for different fitting types is a disadvantage.

### SUMMARY

The present disclosure pertains to electro-fusion couplings and fittings for use with a thermoplastic piping system adapted for use in corrosive waste piping systems. The system incorporates use of plain end fittings with use of electro-fusion couplings and fittings. Plain end pipe and plain end fittings are capable of use with other prior art joining systems such as heat element butt fusion, heat element socket fusion, mechanical joint, solvent cementing or adhesive bonding. Therefore, the electro-fusion system of the present invention can be used individually on a given installation, or several of the listed methods can be combined on a given project, e.g., with different methods used in different portions of the system. Regardless of the method or methods used on a given installation, common fittings can be used interchangeably since the end configuration is always the same.

In the electro-fusion method, the system makes use of full integrity “pressure rated” electro-fusion technology using molded-in wire or post-molding imbedded wire and “clampless” designs for the coupling. The resulting installation in a gravity drainage system is pressure-testable and pressure rated to at least the rating of the component having the lowest pressure rating installed in the system. This is highly desirable for applications involving critical fluids that are to be drained down the systems by gravity due to the unprecedented level of afforded safety factor. The electro-fusion system of the present disclosure results in a relatively much higher level of fusion integrity, and one that is more repeatable for polypropylene, PVDF and other thermoplastic piping systems.

As discussed above, advantages of the present system include full pressure integrity without exterior clamping of the joint during fusion. The coupling wall thickness of the present invention is predetermined to be sufficient to restrain the coupling from expanding during the heat fusion stage of coupling. The thickness of the coupling is equal to or greater than the wall thickness of the associated pipe, thereby providing a pressure rating equal to or greater than the pipe. Further advantages include use in a system of plain end fittings, thereby eliminating the need for short pipe nipples.

Other advantages of the electro-fusion coupling of the present disclosure include the reduced space required for assembly of an electro-fusion coupling compared to a mechanical coupling. For example, a mechanical coupling requires additional space for manipulating a wrench to tighten the mechanical fasteners (bolt and nut) of the mechanical clamp, then slipping the electro-fusion coupling on and connecting the power supply wires to the coupling terminals.

In one embodiment, an electro-fusion drainage system coupling has a tubular body defining an outer surface and an inner surface, the outer surface and the inner surface being substantially parallel, the inner surface defining a passageway from a first end to a second end. A first resistive heating element is disposed in the passageway. The resistive heating element may be disposed in the passageway, e.g., in a spiral groove cut in the interior surface of the body of the coupling with a resistive heating element wire laid down in the groove, or the groove may be a continuous spiral from a first end portion of the coupling to a second end portion. Alternatively, a first spiral groove may be inscribed in the surface of the first end portion to the central portion of the coupling and a second spiral may be inscribed from the central portion to the second end portion of the body, with a first resistive wire disposed in the first spiral groove and a second wire disposed in the second groove. The wires may be electrically connected. In yet another implementation, a tubular preformed sleeve has a resistive heating element comprising a spiral wound wire disposed on an outer surface of the sleeve. A tubular body is over-molded over the sleeve and heating element.

The electro-fusion coupling may include a first radial opening from the inner surface to the outer surface of the body and a second radial opening from the inner surface to the outer surface of the first portion of the body. A first conductive terminal is disposed in the first radial opening and electrically connected to the resistive heating element and a second conductive terminal is disposed in the second radial opening and electrically connected to the resistive heating element.

The resistive heating element of the electro-fusion coupling may be coated with fluoropolymer before being disposed in the groove of the coupling body or coated with fluoropolymer after being disposed in the groove of the coupling body.

In some implementations, the electro-fusion coupling further includes a stop in the passageway of the body, the stop being positioned for contact with a first proximal end portion of first thermoplastic pipe inserted into the passageway of the coupling body. The stop may comprise a continuous circumferential ring of the same material as the body of the coupling and the ring is sized to be partially received in a radial groove milled in the inner surface of the body. The groove is milled in the inner surface before the resistive heating element is put in place.

The electro-fusion coupling may include a pop-up fusion indicator having an annular depression on an outer surface of a portion of the fitting body. The annular depression extends into but not through the sidewall. An integral button of sidewall material is disposed to the center of the annular depression.

The electro-fusion coupling may further comprise a fitting integrally formed on a second end of the coupling. The fitting may be a tee-fitting, elbow-fitting, wye-fitting, or other standard waste discharge system fitting.

In some implementations, the thermoplastic piping system may be in the form of a kit having at least one mechanical coupling with a predetermined interior diameter and predetermined length configured to accept and couple a thermoplastic pipe of a specified outside diameter. The kit further includes at least one electro-fusion coupling having a predetermined interior diameter configured to accept and couple a thermoplastic pipe of the specified outside diameter of the pipe to be coupled by the mechanical coupling. The electro-fusion coupling has a longitudinal length substantially equivalent to the length of the mechanical coupling. The electro-fusion coupling has an internal working pressure equal to or greater than internal working pressure of the mechanical coupling.

Polymeric waste discharge system pipe may be joined using the electro-fusion coupling of the present disclosure by the steps of: providing a first piece and a second piece of polymeric tubular pipe to be joined, each with a proximal terminal end and a proximal end portion adjacent to the proximal terminal end; and providing an electro-fusion coupling (or fitting with electro-fusion ends); inserting the proximal terminal end of the first piece of pipe to be joined in a first end portion of the electro-fusion coupling for a predetermined distance of insertion; inserting the proximal terminal end of the second piece of pipe to be joined in a second end portion of the electro-fusion coupling for a predetermined distance; and applying an electrical current to the resistive element to heat the resistive heating element to a temperature sufficient to fuse each end of the tubular pipe to the coupling absent any external support applied to the outside of the tubular body of the electro-fusion coupling. The method may also include the step of inserting the terminal proximal end of the pipe to be joined into the electro-fusion coupling until the terminal end contacts a stop disposed on the interior surface of the central portion of the coupling.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of an electro-fusion coupling with a resistive heating element in an internal passageway;

FIG. 2 is an end view of the electro-fusion coupling of FIG. 1;

FIG. 3A is a cross-sectional side view of the electro-fusion coupling taken along section 3A-3A of FIG. 2;

FIG. 3B is a cross-sectional side view of an electro-fusion coupling taken along section 3B-3B of FIG. 2 with a resistive heating element configured differently than that of the implementation of FIG. 3A;

FIG. 3C is an enlarged partial cross-section of a portion of FIGS. 3A and 3B illustrating a pop-up fusion indicator and an electrical terminal connector;

FIG. 3D is an enlarged partial cross-section taken along section 3D-3D of FIGS. 3A and 3B illustrating a pop-up fusion indicator and an electrical terminal connector;

FIG. 4 is a partial cross-sectional side view of a polymeric pipe to polymeric pipe connection, using the electro-fusion coupling of FIG. 1;

FIG. 5 is a partial cross-sectional side view of a polymeric pipe to polymeric pipe connection, using a prior art mechanical coupling;

FIG. 6 is a cross-sectional side view of a polymeric pipe to polymeric elbow connection joint, using the electro-fusion coupling of FIG. 1 and a prior art plain end elbow;

FIG. 7 is a partial cross-sectional side view of a polymeric pipe to polymeric elbow connection joint, using a prior art mechanical coupling and a prior art plain end elbow; and

FIG. 8 is a cross-sectional view of elbow fitting with an integrally-formed electro-fusion coupling on at least one end of the elbow joined to a polymeric pipe.

Like reference symbols in the various drawings indicate like elements.

### DETAILED DESCRIPTION

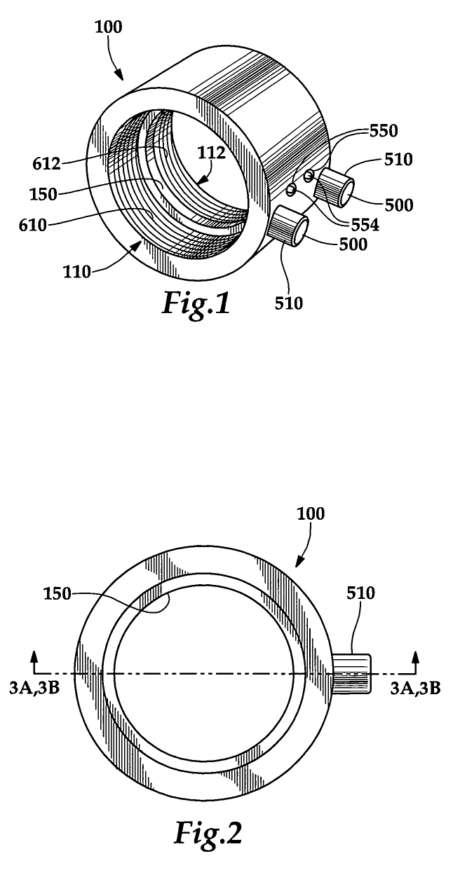

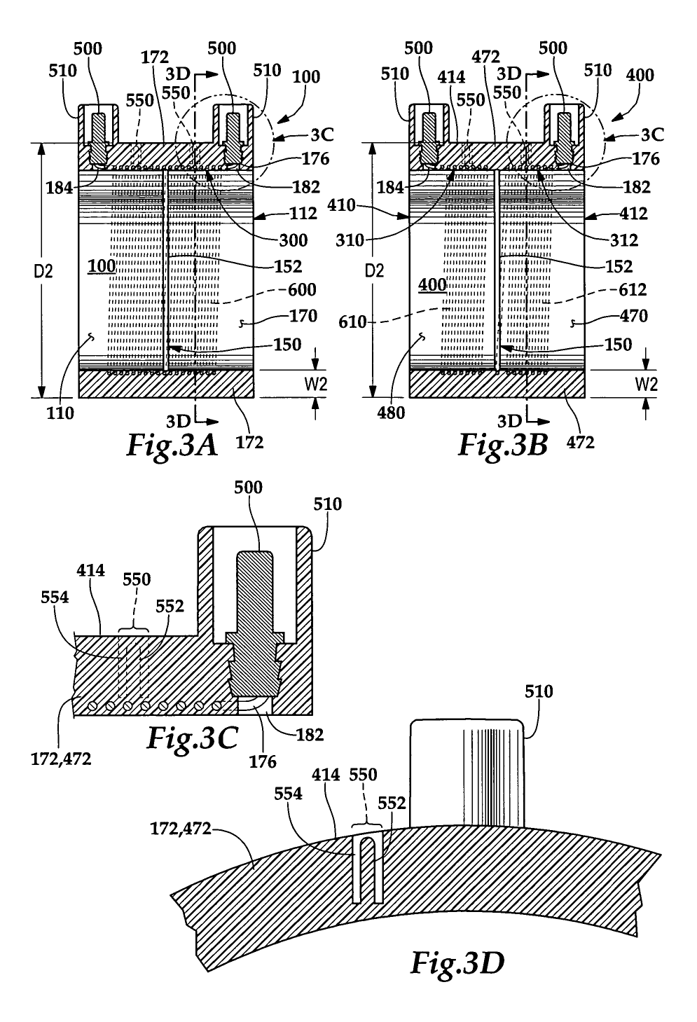

Referring now to FIGS. 1, 2, 3A and 4, an electro-fusion coupling 100 for making electro-fusion (re: ASTM F 1073 and ASTM F 1290) connections between carrier pipe and/or other fittings (hereinafter referred to generally as “couplings”) of various configurations is designed to receive pipes 210 and 212 in opposing socket ends 110 and 112. On the interior of the coupling 170, there is a wire circuit 300. The circuit 300 can consist of one circuit that runs from a near first end 110 of the coupling 100 to a second end 112. Alternatively, the coupling 100 can contain two separate wire circuits, one for each of the opposing socket ends 110, 112, (FIG. 3B). On the interior of the coupling, there may be an optional center stop 150. In this particular implementation, the stop 150 is a full circumferential stop formed of the same material as the coupling body. This is desirable in drainage systems so a smooth interior surface is in the flow area of a gravity draining system. The stop 150 can be configured so that in cross-section, it is essentially “square” to match pipe and fitting ends that are squarely cut. Alternatively, the stop can be implemented with a smooth bevel (i.e., radius), e.g., having a radius of 3 mm or ⅛-inch, with all ends of pipes and fittings advantageously prepared with the same external bevel to match the contour of the bevel so that when the pipe or fitting ends are properly inserted, the ends are essentially flush with the stop resulting in a substantially smooth surface to be encountered by the fluid flow of the draining system.

Several methods of manufacture will be discussed later in this specification. For couplings manufactured by a wire inlaying method, the interior pipe stop can be manufactured using a separate continuous polypropylene ring, which is later assembled into a counterbore 152 on the inside surface 170 of the coupling. This method allows for a full circumferential stop to be used on the inside diameter of the coupling, which is otherwise difficult to achieve with a coupling where the wire is inlaid by this method. A full circumferential stop, or nearly full circumferential stop, is desirable in gravity-flow drainage applications to prevent fluid flow from slowing down, and creating the possibility of fluid back-up.

There are several methods for manufacture of pipe couplings with the wire imbedded beneath the surface, e.g., by molding-in the wire using a preform (U.S. Pat. No. 4,224,505), or by the wire inlaying process (U.S. Pat. Nos. 6,751,840 and 6,530,139). In one implementation of the present disclosure a spiral groove 600 is inscribed on the inner surface 170 of a preformed coupling. It will be understood that the spiral groove may be of a continuous consistent pitch from beginning to end or the pitch of the spiral may change one or more times from the beginning of a groove to the end of the groove. A resistive heating element comprising a wire 176 is disposed in the spiral groove. First and second radial openings 182 and 184 extend from the inner surface 170 to the outer surface 180 of the coupling body. A first conductive terminal 500 is disposed in the first opening and electrically connected to a first end region of the resistive heating element 176 and a second conductive terminal 500 is electrically connected to a second end region of the resistive heating element 176. The terminal connectors 500 can be of any diameter, but it is preferentially one of several standard diameters, including 4.0 mm, 4.7 mm, or other standard pin sizes. Surrounding the terminal connection, the molded coupling body includes a cylindrical terminal protector comprising a protective sleeve 510 formed around the terminal connector 500, so that when the connector is affixed to the heating element leads, it is shielded by the terminal protector, thereby minimizing exposure of an installer to a terminal and reducing any chances for injury due to electrocution. Such terminal protectors may be used with other implementations of the electro-fusion couplings of the present invention.

As illustrated in FIGS. 3A, 3B and 3C on the exterior of the coupling 100, there can be affixed “pop-up” fusion indicators 550. Pop-up fusion indicators have an annular depression 552 into the surface 170, 470 and penetrating into the tubular body sidewall 172, 472. Integral button 554 of sidewall material is left in the center of the annular depression 552. In the preferred embodiment, the annular depression 552 is molded integrally into the sidewall 172, 472 leaving the central indicator button 554 in the center of the annular depression. Alternatively, the annular depression 552 may be drilled in the sidewall 172 or 472. Prior art fusion indicators typically consist of a button and spring inserted into a depression in the sidewall of a coupling. The present design presents a significant cost savings over the prior art because the button is formed integral to the body. Additionally, since the button is integral to the body it will not detach from the coupling and become lost prior to the fusion process. The indicators are forced to rise by molten fusion material in the wall of the coupling, thereby indicating that fusion has taken place. Pop-up-fusion indicators may be used with other implementations of the electro-fusion coupling of the present invention.

Referring to FIG. 3B, in another implementation, the electro-fusion drainage system coupling 400 is similar to the first implementation. The coupling includes a tubular body having: a first end portion proximal to a first end 410; a second end portion proximal to a second end 412; a central portion 414 between the two end portions; and an outer surface 480 and an inner surface 470. The outer surface 480 and the inner surface 470 are substantially parallel with the inner surface defining a passageway from the first end 410 to the second end 412. A first spiral groove 610 is inscribed in the inner surface 470 extending from the central portion 414 of the body. The inscribing tool changes the pitch of inscribing in the central portion 414 leaving a space for the stop ring 150 in the central portion and a second spiral groove 612 is inscribed in the inner surface 470 extending from the central portion 414 of the body the second portion 412 of the body. A first resistive heating element comprising a wire 310 is disposed in the first spiral groove 610 and a second resistive heating element 312 comprising a wire is disposed in the second spiral groove 612. The first and second heating elements may be electrically connected. Alternatively, a single wire may be laid down from the first portion 410 across the center portion 414 to the second portion 412. First and second radial openings 182 and 184 extend from the inner surface 470 to the outer surface 480 of the coupling body. A first conductive terminal 510 is disposed in the first opening and electrically connected to the resistive heating element and a second conductive terminal 510 is electrically connected to the resistive heating element. The coupling 400 may also include a stop 150 and fusion indicators 550 as illustrated and discussed in the first implementation disclosed in FIG. 3A.

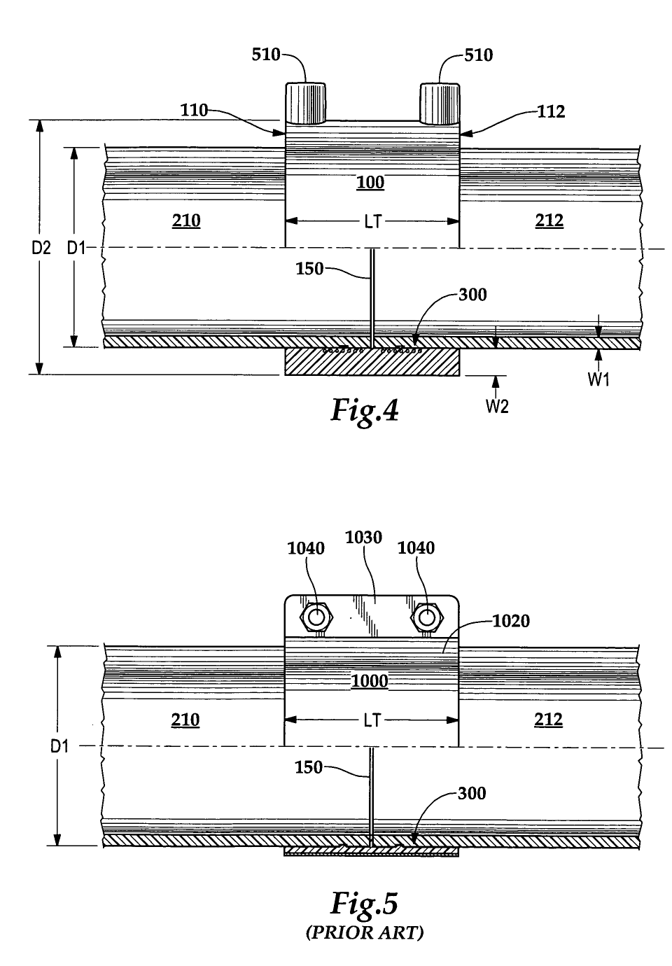

Referring now to FIG. 4, the electro-fusion coupling 100 of the present disclosure joins two pieces of pipe 210 and 212 with outside diameter D₁. The inside diameter of the coupling is substantially equal to the outside diameter D₁ of the pipe to be joined. The outside diameter of the coupling is denoted as D₂. The overall axial length of the coupling 100 is illustrated as L_{T}. Referring in comparison to FIG. 5, a prior art mechanical coupling 1000 (manufactured by the assignee of this application) joins a pipe of outside diameter D₁ having the same overall longitudinal length L_{T}. The prior art mechanical coupling 1000 includes a polymeric sleeve 1010 placed in contact with the pipes 210 and 212 to be joined and an exterior metal sleeve 1020 with ears 1030 and conventional fasteners 1040. The common longitudinal length L_{T} permits interchangeability of the mechanical and electro-fusion couplings on the same construction site. Applicant believes the longitudinal length L_{T} is shorter than any commercially available electro-fusion coupling of the same pressure rating. Approximate internal diameter, external diameter and total length of one embodiment of the electro-fusion coupling is in the Table 1 below.

TABLE 1

Coupling

| Nominal Size | 3″ | 4″ | 6″ | 8″ |
|---|---|---|---|---|
| D₁ | 4.315 | 5.450 | 7.70 | 9.7 |
| D₂ | 3.524 | 4.303 | 6.236 | 7.768 |
| L_{T} | 8.500 | 8.500 | 9.500 | 9.500 |

It will be understood that the dimensions in Table 1 are for illustrative purposes and not limiting on the scope of the present invention.

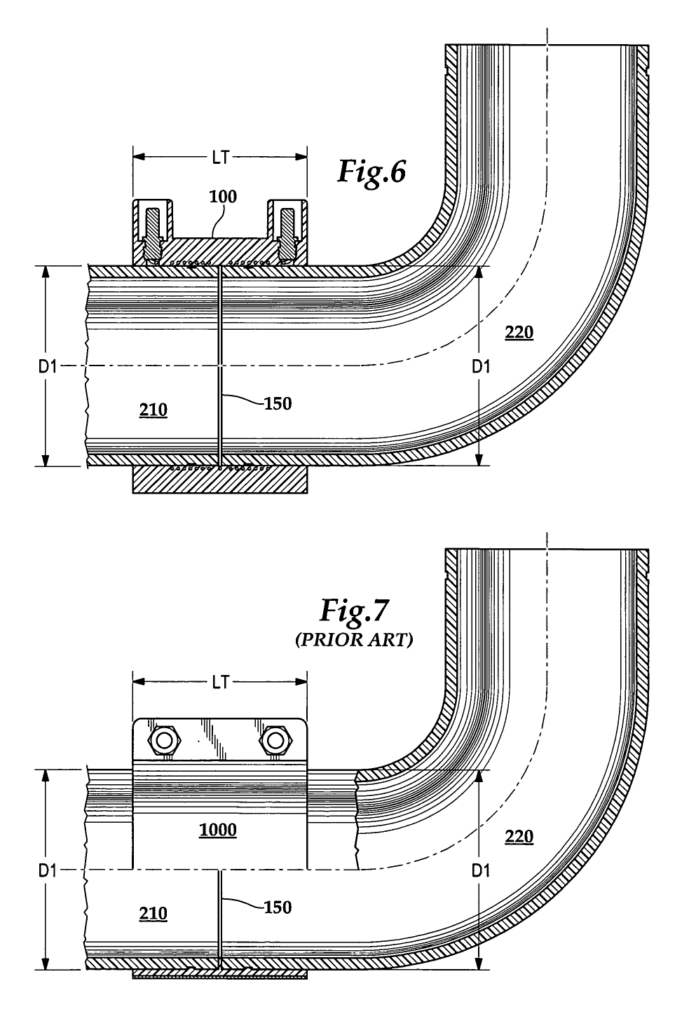

Referring to FIGS. 6 and 7, therein is illustrated a polymeric elbow 220 joining to a polymeric pipe 210 with a polymeric coupling 100 (FIG. 6) and with a standard prior art mechanical coupling 1000 (FIG. 7). Again, the prior art clamp has total longitudinal length L_{T} equal to the longitudinal length L_{T} of the electro-fusion coupling, which permits interchangeability of the mechanical and electro-fusion couplings on the same construction site. Referring again to FIG. 3, the wall thickness W₂ of the coupling 100 is predetermined to be of thickness sufficient to restrain the coupling from expanding during the heat fusion stage of the coupling process. The thickness of the pipe coupling W₂ is equal to or greater than the wall thickness W₁ of the pipe to be joined.

The electro-fusion couplings 100, 400 and 700 are designed with an internal working pressure rating equal to or greater than that of an equivalent mechanical coupling 1000.

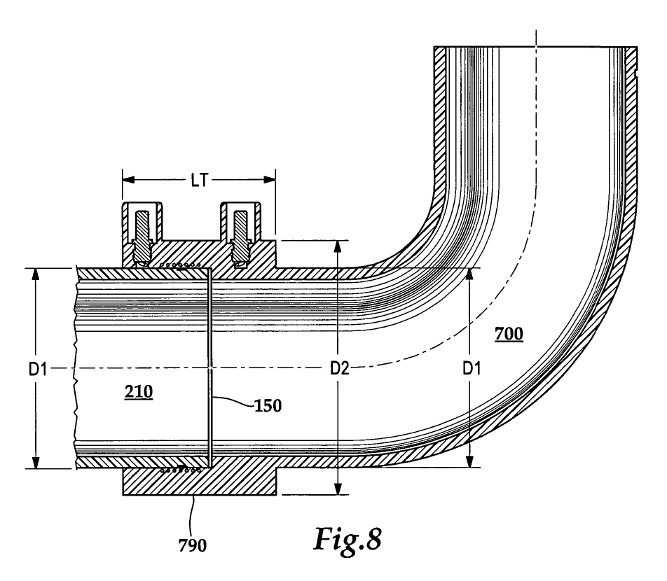

Referring now to FIG. 8, an elbow fitting 700 has an integral coupling 790 formed on one end. The external diameter of the electro-fusion coupling end of the elbow fitting is D2, which is the same outside diameter (D2) of the electro-fusion fitting 100, 400 and 800.

In some implementations, it is desirable to protect the wire resistive heating elements 600, 610, 612 with a tough, high temperature corrosion resistant coating, e.g., fluoropolymers such as PFA (one of the grades of Teflon®) or polyamide-imide (PAI), on the wire. This is especially desirable when using chemically-reactive wire substances such as copper. Copper is beneficial due to its electrical properties in helping to minimize the required voltages for fusion, but it can react readily when in contact with corrosive acids and caustic solutions. Copper, when used with PP systems, may also induce stress cracks in polypropylene. In particular, copper ions, freed during reaction with acids and caustic solutions, can function as a stress-cracking reagent, which, if stress is present in the system, can lead to complete fracturing of the joints. Thus, it is desirable to protect the wire, e.g., by means of a coating, as a conservative measure. It is further beneficial to protect the wire with a coating that also serves a dielectric function so that if wires migrate during the fusion, the dielectric characteristic helps to prevent the wires from burning out or shorting out.

A number of embodiments of the invention have been described. Nevertheless, it will be understood that various modifications may be made without departing from the spirit and scope of the invention. Accordingly, other embodiments are within the scope of the following claims.

What is claimed is:

1. An electro-fusion drainage system coupling, said coupling comprising a tubular body selected from the group consisting of polypropylene and PVDF, said body including:
a first end portion proximal to a first end;
a second end portion proximal to a second end;
a central portion between the two end portions;
an outer surface of the central portion and an inner surface of the central portion, the outer and inner surface being substantially parallel, the inner surface defining a passageway from the first end to the second end;
a spiral groove in the inner surface extending from the first portion of the body toward the second portion of the body; and
a resistive heating element comprising a wire disposed in said spiral groove.

2. The electro-fusion coupling of claim 1 further comprising:
a first radial opening from the inner surface to the outer surface of the body;
a second radial opening from the inner surface to the outer surface of the first portion of the body;
a first conductive terminal disposed in the first radial opening, said first conductive terminal electrically connected to the resistive heating element; and
a second conductive electrical terminal disposed in the second radial opening, said second conductive terminal electrically connected to the resistive heating element.

3. The electro-fusion coupling of claim 2 further including a cylindrical terminal protector disposed around each conductive terminal, said protector attached to the surface of the coupling adjacent to the radial opening containing the conductive terminal.

4. The electro-fusion coupling of claim 2 wherein the resistive heating element is precoated with fluoropolymer before being disposed in the groove of the coupling body.

5. The electro-fusion coupling of claim 1 wherein the resistive heating element is post-coated with fluoropolymer after being disposed in the groove of the coupling body.

6. The electro-fusion coupling of claim 1 further comprising a full circumferential stop surface in the passageway of the body, said stop surface positioned for contact with a first proximal end portion of first thermoplastic pipe inserted into the passageway of said coupling body.

7. The electro-fusion coupling of claim 6 wherein the stop surface comprises a full circumferential ring of the same material as the tubular body, said ring sized to be partially received in a radial groove milled in the inner surface of the body before the spiral groove is milled in the inner surface and said stop surface partially extending from the groove, wherein said ring is positioned in the radial groove after the heating element is positioned in the spiral groove.

8. The electro-fusion coupling of claim 1 further comprising a pop-up fusion indicator comprising:
an annular depression on an outer surface of a portion of the fitting body, said depression extending into the sidewall of the tubular body but not therethrough; and
an integral button of sidewall material disposed in the center of the annular depression.

9. The electro-fusion coupling of claim 1 further comprising a fitting integrally formed on one end of said coupling, the fitting selected from the group consisting of tee-fittings, elbow-fittings and wye-fittings.

10. An electro-fusion drainage system coupling, said coupling comprising a tubular body selected from the group of polypropylene and PVDF, said body including:
a first end portion proximal to a first end;
a second end portion proximal to a second end;
a central portion between the two end portions;
an outer surface of the central portion and an inner surface of the central portion, the outer surface and the inner surface being substantially parallel, the inner surface defining a passageway from the first end to the second end;
a first spiral groove in the inner surface extending from the first portion of the body toward the central portion of the body;
a second spiral groove in the inner surface extending from the central second portion of the body toward the body;
a first resistive heating element comprising a wire disposed in the first spiral groove; and
a second resistive heating element comprising a wire disposed in the second spiral groove.

11. The electro-fusion coupling of claim 10 wherein the first and second heating elements are electrically connected.

12. The electro-fusion coupling of claim 10 wherein the first spiral groove and the second spiral groove are connected by an intermediate spiral groove having a different pitch in the central portion of the body.

13. The electro-fusion coupling of claim 12 wherein the first and second heating elements are a continuous wire disposed in the first spiral groove, the intermediate spiral groove and the second spiral groove.

14. The electro-fusion coupling of claim 10 further comprising:
a first radial opening from the inner surface to the outer surface of the body;
a second radial opening from the inner surface to the outer surface of the first portion of the body;
a first conductive terminal disposed in the first radial opening, said first conductive terminal electrically connected to the resistive heating element; and
a second conductive electrical terminal disposed in the second radial opening, said second conductive terminal electrically connected to the resistive heating element.

15. The electro-fusion coupling of claim 10 further including a cylindrical terminal protector disposed around each conductive terminal, said protector attached to the surface of the coupling adjacent to the radial opening containing the conductive terminal.

16. The electro-fusion coupling of claim 10 further comprising a full circumferential stop surface in the passageway of the body, said stop positioned for contact with a first proximal end portion of a first thermoplastic pipe inserted into the passageway of said coupling body.

17. The electro-fusion coupling of claim 16 wherein the stop surface comprises a full circumferential ring of the same material as the tubular body, said ring sized to be partially received in a radial groove milled in the inner surface of the body before the spiral groove is milled in the inner surface and said stop surface partially extending from the groove, wherein said ring is positioned in the radial groove after the heating element is positioned in the spiral groove.

18. The electro-fusion coupling of claim 10 further comprising a pop-up fusion indicator comprising:
an annular depression on an outer surface of a portion of the fitting body, said depression extending into the sidewall of the tubular body but not through; and
an integral button of sidewall material disposed in the center of the annular depression.

19. The electro-fusion coupling of claim 11 further comprising a fitting integrally formed on one end of said coupling, the fitting being selected from the group consisting of tee-fittings, elbow-fittings and wye-fittings.

20. A kit comprising:
at least one mechanical coupling having a predetermined interior diameter configured to accept and couple a thermoplastic pipe of a specified outside diameter, said mechanical coupling having a predetermined longitudinal length;
at least one electro-fusion coupling comprising a tubular body selected from the group of polypropylene and PVDF, said body having a predetermined interior diameter configured to accept and couple a thermoplastic pipe of the specified outside diameter of the pipe to be coupled by the mechanical coupling, said electro-fusion coupling having a longitudinal length substantially equivalent to the length of the mechanical coupling, said electro-fusion coupling further including:
a first end portion proximal to a first end;
a second end portion proximal to a second end;
a central portion between the two end portions;
an outer surface of the central portion and an inner surface of the central portion, the outer surface being substantially parallel to the inner surface, the inner surface defining a passageway from the first end to the second end;
a spiral groove in the inner surface extending from the first portion of the body toward the second portion of the body; and
a resistive heating element comprising a wire disposed in said spiral groove.

21. The kit of claim 20 wherein the electro-fusion coupling has an internal working pressure equal to or greater than internal working pressure of the mechanical coupling.

22. The kit of claim 20 wherein the electro-fusion coupling further comprises a full circumferential stop surface in the passageway of the body, said stop surface positioned for contact with a first proximal end portion of first thermoplastic pipe inserted into the passageway of said coupling body.

23. The kit of claim 22 wherein the stop surface comprises a full circumferential ring of the same material as the tubular body, said ring sized to be partially received in a radial groove milled in the inner surface of the body before the spiral groove is milled in the inner surface and said stop surface partially extending from the groove, wherein said ring is positioned in the radial groove after the heating element is positioned in the spiral groove.

24. The kit of claim 20 wherein the electro-fusion coupling further comprises a fusion indicator comprising:
an annular depression on an outer surface of a portion of the fitting body, said depression extending into the sidewall of the tubular body but not through; and
an integral button of sidewall material disposed in the center of the annular depression.

25. The kit of claim 20 wherein the electro-fusion coupling further comprises a fitting integrally formed on one end of said coupling, the fitting selected from the group consisting of tee-fittings, elbow-fittings and wye-fittings.

26. A kit comprising:
at least one mechanical coupling having a predetermined interior diameter configured to accept and couple a thermoplastic pipe of a specified outside diameter, said mechanical coupling having a predetermined longitudinal length;
at least one electro-fusion coupling having a tubular body selected from the group consisting of polypropylene and PVDF, said body coupling having a predetermined interior diameter configured to accept and couple a thermoplastic pipe of the specified outside diameter of the pipe to be coupled by the mechanical coupling, said electro-fusion coupling having a longitudinal length substantially equivalent to the length of the mechanical coupling, said electro-fusion coupling further including:
a first end portion proximal to a first end;
a second end portion proximal to a second end;
a central portion between the two end portions;
an outer surface and an inner surface, the outer surface and the inner surface being substantially parallel, the inner surface defining a passageway from the first end to the second end;
a first spiral groove in the inner surface extending from the first portion of the body toward the central portion of the body;
a second spiral groove in the inner surface extending from the second portion of the body toward the central portion of the body;
a first resistive heating element comprising a wire disposed in the first spiral groove; and
a second resistive heating element comprising a wire disposed in the second spiral groove.

27. The electro-fusion coupling of claim 26 further comprising a full circumferential stop surface in the passageway of the body, said stop surface positioned for contact with a first proximal end portion of first thermoplastic pipe inserted into the passageway of said coupling body.

28. The electro-fusion coupling of claim 27 wherein the stop surface comprises a full circumferential ring of the same material as the tubular body, said ring sized to be partially received in a radial groove milled in the inner surface of the body before the spiral groove is milled in the inner surface and said stop surface partially extending from the groove, wherein said ring is positioned in the radial groove after the heating element is positioned in the spiral groove.

29. The electro-fusion coupling of claim 26 further comprising a pop-up fusion indicator comprising:
an annular depression on an outer surface of a portion of the fitting body, said depression extending into the sidewall of the tubular body but not through; and
an integral button of sidewall material disposed in the center of the annular depression.

30. The electro-fusion coupling of claim 26 further comprising a fitting integrally formed on one end of said coupling, the fitting selected from the group consisting of tee-fittings, elbow-fittings and wye-fittings.

31. The kit of claim 26 wherein the electro-fusion coupling has an internal working pressure equal to or greater than internal working pressure of the mechanical coupling.

32. An electro-fusion drainage system fitting comprising a body selected from a group consisting of polypropylene and PVDF, said body including:
a fitting portion, said fitting portion selected from a group consisting of tee-fittings, elbow-fittings and wye-fittings;
at least one electro-fusion end portion, said electro-fusion end portion comprising a tubular body selected from a group consisting of polypropylene and PVDF molded with the fitting portion, said electro-fusion end portion including:
an outer surface and an inner surface, the outer surface and the inner surface being substantially parallel, the inner surface defining a passageway;
a spiral groove in the inner surface; and
a resistive heating element comprising a wire disposed in said spiral groove.

33. A method of joining polymeric drainage pipe using electro-fusion, said method comprising the steps of:
providing a first piece and a second piece of polymeric tubular pipe to be joined, each with a proximal terminal end and a proximal end portion adjacent to the proximal terminal end
providing an electro-fusion coupling, said coupling comprising a generally tubular body selected from the group consisting of polypropylene and PVDF, said body including:
a first end portion proximal to the first end,
a second end portion proximal to the second end,
a central portion between the two end portions,
an outer surface of the central portion and an inner surface of the central portion, the outer surface and inner surface being substantially parallel, and the inner surface defining a passageway from the first end to the second end,
a resistive heating element disposed in the passageway of the coupling;
inserting the proximal terminal end of the first piece of pipe to be joined in a first end portion of the electro-fusion coupling a predetermined distance of insertion;
inserting the proximal terminal end of the second piece of pipe to be joined in a second end portion of the electro-fusion coupling a predetermined distance; and
applying an electrical current to the resistive element and heating the resistive heating element to a temperature sufficient to fuse each end of the tubular pipe to the coupling without external support of the outside of the tubular body of the electro-fusion coupling.

34. The method of claim 33 further comprising the step of inserting the terminal proximal end of the pipe into the electro-fusion coupling until the terminal end contacts a stop disposed in the passageway of the central portion of the coupling.
